(19) United States
(12) Patent Application Publication
(10) Pub. No.: US 2008/0073356 A1
(43) Pub. Date: Mar. 27, 2008

(54) Safety fryer

(76) Inventor: Ron A. Sulosky, Windber, PA (US)

Correspondence Address: Galasso & Associates, LP, P.O. Box 26503, Austin, TX, 78755-0503, US

(21) Appl. No.: 11/526,507

(22) Filed: Sep. 25, 2006

(51) Int. Cl. A47J 37/01

(52) U.S. Cl. 220/573.1

(57) ABSTRACT

Safety Fryer is a fryer device with an inner chamber having drain holes near the top and an outer chamber that fits around and attaches to the inner chamber and catches any grease escaping through the drain holes. To use Safety Fryer, a user simply fills the inner chamber with oil or water. When the grease or water is at the proper temperature, the user places the desired item inside the inner chamber. If the food item causes the water or oil level to rise too close to the top of the inner chamber, the water or oil will flow out the drain holes into the outer chamber, preventing dangers associated with overflow. If the level again decreases, the water or oil will be permitted to flow back into the inner chamber through the drain holes.

### CROSS REFERENCE TO RELATED APPLICATIONS

This United States Non-Provisional patent application does not claim priority to any United States Provisional Patent applications or any foreign patent applications.

### FIELD OF THE DISCLOSURE

The disclosures made herein relate generally to the food preparation industry. The invention discussed herein is in the general classification of fryers.

### BACKGROUND

Many families enjoy cooking at home. Eating at home is often less expensive than eating at a restaurant and also provides quality time around the dinner table for family members. Holidays such as Thanksgiving, Christmas, Easter and the Fourth of July are just a few occasions when a family prepares larger meals together.

In recent years, turkey fries and crawfish boils have become increasingly popular. A propane tank, burner and a large fryer pot are often used for these events. The fryer is filled with a large amount of cooking oil or water and a lid can be placed over the top of the fryer when it is placed on the burner. Unfortunately, the increased popularity of these events has lead to more grease accidents, burns and fires due to the overflow of oil or water from the fryer and lid.

Hence, there is a need in the art for an effective, safe and inexpensive device for outdoor frying and cooking that decreases the risk of water or grease overflow.

### SUMMARY OF THE DISCLOSURE

Safety Fryer is a fryer with an inner chamber having drain holes near the top and an outer chamber that fits around and attaches to the inner chamber and catches any grease escaping through the drain holes.

The principal object of this invention is to provide a device that prevents grease fires.

Another object of this invention is to provide a device that prevents burns or accidents associated with water or grease overflow from a fryer.

Yet another object of this invention is to provide an affordable device for safely frying or boiling foods.

### BRIEF DESCRIPTION OF THE DRAWINGS

FIG. 1 depicts a perspective view of the preferred embodiment of the invention.

FIG. 2 depicts an overhead view of the preferred embodiment of the invention with the lid removed.

### DETAILED DESCRIPTION OF THE DRAWINGS

The preferred embodiment of Safety Fryer is comprised of a cylindrical inner chamber having drain holes spaced at ninety-degree increments around the upper portion of the inner chamber and a cylindrical outer chamber attached to the inner chamber that catches any grease or water emanating from the drain holes on the inner chamber.

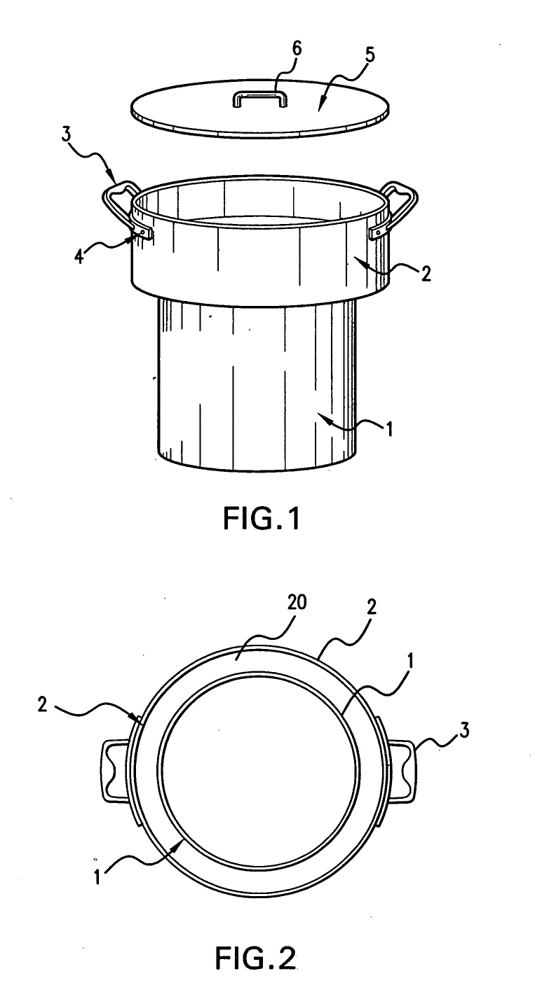

FIG. 1 shows a perspective view of the preferred embodiment of the invention. An inner chamber 1 that is approximately seventeen inches in height is attached to an outer chamber 2 that is approximately six inches in height. The inner chamber 1 is slightly taller than a standard fryer. The inner chamber 1 and outer chamber 2 are cylindrical and are made of aluminum. The inner chamber 1 has a diameter of twelve inches while the outer chamber 2 has a diameter of sixteen inches. The inner chamber 1 has four drain holes (not pictured) evenly spaced around its upper circumference. Each of the four drain holes is one-half inch in diameter. The outer chamber 2 is attached to the inner chamber 1 beneath these drain holes.

The outer chamber 2 has two handles 3 on opposite sides that are attached via rivets 4. The handles 3 are also made of aluminum. A lid 5 with a lid handle 6 in the center is also made of aluminum and is removable from the outer chamber 2. The lid 5 is circular in shape and is made to correspond with the diameter of the outer chamber 2.

FIG. 2 shows an overhead view of the preferred embodiment of the invention with the lid removed. The outer chamber 2 has a floor 20 that attaches to the outer edge of the inner chamber 1 beneath the four drain holes. The handles 3 are also visible from the overhead view.

To use Safety Fryer, a user simply places the device on the burner, fills the inner chamber with oil or water, starts the flow of propane and ignites the burner. When the grease or water is at the proper temperature, he places the desired food item inside the inner chamber and closes the lid on the upper chamber, if appropriate. If the food item displaces a sufficient amount of the water or oil, the liquid level will rise too close to the top of the inner chamber and the water or oil will flow out the drain holes into the outer chamber, preventing dangers associated with overflow. If the level again decreases, the water or oil will be permitted to flow back into the inner chamber through the drain holes.

The materials utilized for Safety Fryer may vary widely but could include metal components. The metals would ideally be selected from available steel or alloys of steel and aluminum. Stainless steel is resistant to corrosion or rusting associated with exposure to water and moist air. Any of various steel alloys with at least ten percent chromium and perhaps other elements that would increase the resistance to corrosion or rusting would also be ideal. The production process related to the use of these metals insures that the metal is non-corrosive, durable and strong. The selected metal should have high impact strength and be capable of accepting and retaining coloring materials for an extended length of time.

It should be obvious that the components of the present invention can be of various shapes and sizes. It should also be obvious that the components of the invention can be made of different types of metals or other suitable materials and can be of any color or design.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A cooking device comprising:
(a) an inner chamber having a hole; and
(b) an outer chamber attached to the inner chamber beneath the hole;

2. The device of claim 1 wherein the inner chamber is cylindrical.

3. The device of claim 1 wherein the outer chamber is cylindrical.

4. The device of claim 1 wherein the inner chamber is aluminum.

5. The device of claim 1 wherein the outer chamber is aluminum.

6. The device of claim 1 wherein the inner chamber is stainless steel.

7. The device of claim 1 wherein the outer chamber is stainless steel.

8. The device of claim 1 wherein the hole is located on the upper one-third of the inner chamber.

9. The device of claim 1 wherein the outer chamber has a first handle and a second handle on opposite sides.

10. The device of claim 9 wherein the first handle and the second handle are attached to the outer chamber via a set of rivets.

11. The device of claim 9 wherein the first handle and the second handle are made of aluminum.

12. The device of claim 9 wherein the first handle and the second handle are made of stainless steel.

13. The device of claim 1 further comprising
a lid that attaches to the outer chamber.

14. The device of claim 13 wherein the lid is made of aluminum.

15. The device of claim 13 wherein the lid is made of stainless steel.

16. The device of claim 13 further comprising
a lid handle attached to the lid.

17. The device of claim 16 wherein the lid handle is made of aluminum.

18. The device of claim 13 wherein the lid is removable from the outer chamber and corresponds in shape and size with the perimeter of the outer chamber.

19. A cooking device comprising:
(a) an inner chamber; and
(b) an outer chamber that extends above the top of the inner chamber and that is connected to the inner chamber.

20. A cooking device comprising:
(a) an inner chamber that is cylindrical and made of aluminum having a set of four holes spaced evenly around the upper perimeter;
(b) an outer chamber that is cylindrical and made of aluminum attached to the inner chamber beneath the set of four holes;
(c) a first handle and a second handle made of aluminum located on opposite sides of the outer chamber;
(d) a lid made of aluminum that is attachable to and removable from the outer chamber; and
(e) a lid handle attached to the lid.
